(19) United States
(12) Patent Application Publication
(10) Pub. No.: US 2016/0089855 A1
(43) Pub. Date: Mar. 31, 2016

(54) MORPHING FORM FACTOR MATERIAL

(71) Applicant: Intel Corporation, Santa Clara, CA (US)

(72) Inventors: Paul Gwin, Orangevale, CA (US); Mark Sprenger, Folsom, CA (US)

(21) Appl. No.: 14/498,129

(22) Filed: Sep. 26, 2014

(51) Int. Cl. B32B 7/02; B32B 27/32; B29C 61/00; B32B 27/34

(52) U.S. Cl. CPC B32B 7/02; B32B 27/34; B32B 27/32; B29C 61/003; B32B 2307/738; B32B 2457/00; B29K 2077/00

(57) ABSTRACT

Particular embodiments described herein provide for a morphing material that may include an outer layer, a polymer layer, and an inner core. The polymer layer can be between the inner core and the outer layer. The inner core can include a shape memory polymer and the shape memory polymer can have a known glass transition temperature. The morphing material can be mechanically deformed to a temporary shape when a temperature of the shape memory polymer is at or above the glass transition temperature.

### TECHNICAL FIELD

Embodiments described herein generally relate to the field of form factor materials and, more particularly, to morphing form factor materials.

### BACKGROUND

End users have more electronic device choices than ever before. A number of prominent technological trends are currently afoot (e.g., more computing devices, more detachable displays, etc.), and these trends are changing the electronic device landscape. One of the technological trends is a wearable computer. Wearable computers (also known as body-borne computers or wearables) are miniature electronic devices that are worn by a user under, with, or on top of clothing. This class of wearable technology has been developed for general or special purpose information technologies and media development. Wearable computers are especially useful for applications that require more complex computational support than just hardware coded logics (e.g., a digital watch). One problem with wearable computers is that there are an almost infinite number of variations in the user's form and it can be difficult to adjust the fit of the wearable computer to a user's preference. A1so, users may want to adjust the shape of a device, not just a wearable computer. Hence there is a need for a morphing form factor material so the shape of a device can be altered to accommodate a user's preference.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified schematic diagram illustrating an embodiment of a morphing form factor material, in accordance with one embodiment of the present disclosure;

FIG. 1B is a simplified schematic diagram illustrating an embodiment of a morphing form factor material, in accordance with one embodiment of the present disclosure;

FIG. 2 is a simplified schematic diagram illustrating an embodiment of a morphing form factor material, in accordance with one embodiment of the present disclosure;

FIG. 3 is a simplified block diagram illustrating example details associated with an embodiment of a morphing form factor material, in accordance with one embodiment of the present disclosure;

FIG. 4 is a simplified block diagram illustrating example details associated with an embodiment of a morphing form factor material, in accordance with one embodiment of the present disclosure;

FIG. 5A is a simplified schematic diagram illustrating an embodiment of a morphing form factor material, in accordance with one embodiment of the present disclosure;

FIG. 5B is a simplified schematic diagram illustrating an embodiment of a morphing form factor material, in accordance with one embodiment of the present disclosure;

FIG. 5C is a simplified schematic diagram illustrating an embodiment of a morphing form factor material, in accordance with one embodiment of the present disclosure;

FIG. 6A is a simplified schematic diagram illustrating an embodiment of an electronic device, in accordance with one embodiment of the present disclosure;

FIG. 6B is a simplified schematic diagram illustrating an embodiment of an electronic device, in accordance with one embodiment of the present disclosure;

FIG. 7 is a simplified block diagram illustrating an embodiment of example details associated with a morphing form factor material, in accordance with one embodiment of the present disclosure;

FIG. 8 is a simplified block diagram illustrating an embodiment of example details associated with a morphing form factor material, in accordance with one embodiment of the present disclosure;

FIG. 9 is a simplified flow diagram illustrating potential operations associated with one embodiment of the present disclosure;

FIG. 10 is a simplified flow diagram illustrating potential operations associated with one embodiment of the present disclosure;

FIG. 11 is a simplified block diagram associated with an example ARM ecosystem system on chip (SOC) of the present disclosure; and

FIG. 12 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

Overview

A morphing material is provided in one embodiment and in one particular example implementation, the morphing material may include an outer layer, a polymer layer, and an inner core. The polymer layer can be between the inner core and the outer layer. The inner core can include a shape memory polymer and the shape memory polymer can have a known glass transition temperature. The morphing material can be mechanically deformed to a temporary shape when a temperature of the shape memory polymer is at or above the glass transition temperature.

The shape memory polymer can include covalent bonds and some of the covalent bonds may be broken when the temperature of the shape memory polymer is at or above the glass transition temperature. In addition, a slip plane can be created when the temperature of the shape memory polymer is at or above the glass transition temperature and the slip plane can allow the polymer layer and outer layer to act at least partially independent of the inner core. The morphing material includes a permanent shape and the morphing material can transition from the temporary shape to the permanent shape when the temperature of the shape memory polymer is at or above the glass transition temperature.

In other embodiments, the polymer layer includes fibers to increase the stiffness of the morphing material. Additionally, the morphing material can also include a second shape memory polymer, where the second shape memory polymer has a known second glass transition temperature that is different than the glass transition temperature of the first shape memory polymer. In certain examples, the morphing material can also include a second inner core, where the second inner core is next to the inner core and the second inner core includes a second shape memory polymer and the second shape memory polymer has a known second glass transition temperature. In some specific instances, the glass transition temperature is about the temperature of a user that is using the morphing material.

### Example Embodiments

The following detailed description sets forth embodiments of apparatuses, methods, and systems relating to morphing form factor material. Some embodiments include morphing form factor material for an electronic device. Features such as structure(s), function(s), and/or characteristic(s), for example, are described with reference to one embodiment as a matter of convenience; various embodiments may be implemented with any suitable one or more of the described features.

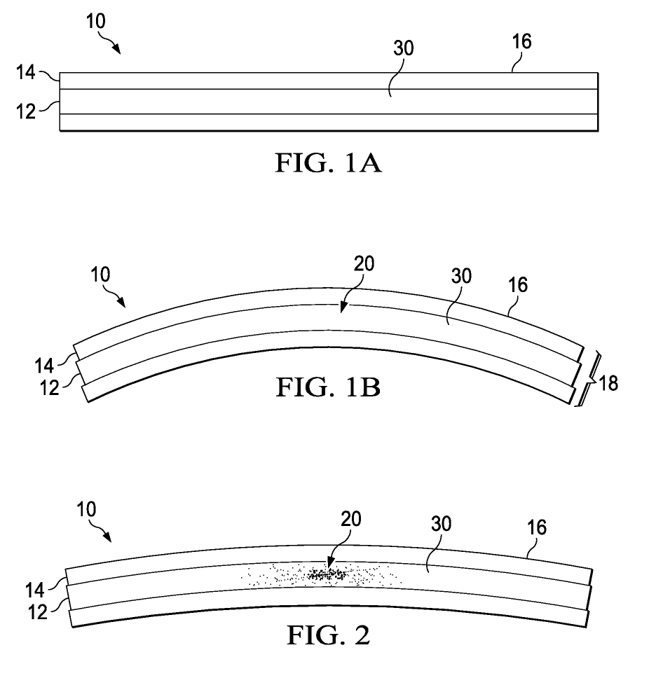

FIG. 1A is a simplified schematic diagram illustrating an embodiment of a morphing form factor material 10, in accordance with one embodiment of the present disclosure. Morphing form factor material 10 can include an inner core 12, a polymer layer 14, and an outer layer 16. Inner core 12 may include a shape memory polymer (SMP) 30. Outer layer 16 can be fiber reinforced. In an example, inner core 12 inside of morphing form factor material 10 can be heated to a glass transition temperature (Tg) for SMP 30. By heating inner core 12 to the Tg for SMP 30, morphing form factor material 10 can be made to take on a new form or shape.

Turning to FIG. 1B, FIG. 1B is a simplified schematic diagram illustrating an embodiment of morphing form factor material 10, in accordance with one embodiment of the present disclosure. As illustrated in FIG. 1B, inner core 12 was heated to the Tg for SMP 30 and inner core 12, polymer layer 14, and outer layer 16 have deformed (e.g. morphing form factor material 10 has been bent as illustrated in FIG. 1B). By cooling inner core 12 below Tg after it was heated, morphing form factor material 10 can retain the temporary shape illustrated in FIG. 1B until inner core 12 is again heated to the Tg for SMP 30. When heated to the Tg for SMP 30, if unconstrained, morphing form factor material 10 will return to its permanent shape, (illustrated in FIG. 1A) or may be formed to a new shape using mechanical force. The Tg for SMP 30 depends on the compounds used when creating inner core 12 and the specific types of materials that make up SMP 30. Curvature 18 of morphing form factor material 10 is uniform and controlled due to slip plane region 20.

Slip plane region 20 is an area of inner core 12 that can become low in shear modulus (shear fluidity) and become a controlled slip plane when SMP 30 is heated to the Tg. Slip plane region 20 enables polymer layer 14 and outer layer 16 to act independently or at least partially independent of inner core 12 when bending so that bending morphing form factor material 10 becomes easy and curvature 18 is uniform and controlled. When morphing form factor material 10 cools, the structure of inner core 12 can be stiff and rigid, thus keeping morphing form factor material 10 in the desired shape.

For purposes of illustrating certain example features of morphing form factor material 10, the following foundational information may be viewed as a basis from which the present disclosure may be properly explained.

The wearable's market as compared to the traditional computer device market has an added obstacle in that there are an almost infinite number of variations in the human form. However, current wearable computers do not achieve a custom fit to the user as if the wearable computer was designed custom for the user. Hence, there is a need to deliver conforming (morphing) technology into the wearable's market that will enable a customized fit for the myriad of sizes and form factors necessary. In addition, a user may want to morph or change the shape of a device into a temporary shape.

In an embodiment, morphing form factor material 10 can be configured to allow the shape of an electronic device (or other non-electronic device) to be changed to a temporary shape (e.g., a custom fit, new form factor, etc.) and then when desired, can be returned to an original permanent shape. In an example, morphing form factor material 10 can be created with an original shape and the original shape may the permanent shape or shape the material can return to when a SMP in morphing form factor material 10 is heated to a Tg for the SMP and morphing form factor material 10 is not constrained or mechanically manipulated. By heating morphing form factor material 10 to a Tg for SMP 30 in inner core 12 and applying mechanical force, morphing form factor material 10 can be made to take on a new form or a temporary shape. By cooling morphing form factor material 10, morphing form factor material 10 can retain the temporary shape until SMP 30 in inner core 12 is heated to the Tg for SMP 30 again. When heated to Tg, morphing form factor material 10, if unconstrained or not mechanically manipulated, will return to its permanent shape (shape recovery) or may be formed, with mechanical force, to a new temporary shape. The Tg for SMP 30 depends on the compounds used when creating inner core and the specific types of materials that make up SMP 30.

The term “Tg” refers to the temperature that a material will undergo glass transition. The term glass transition (or glass-liquid transition) refers to the reversible transition in amorphous materials (or in amorphous regions within semicrystalline materials) from a hard state into a molten or rubber-like state. Despite the massive change in the physical properties of a material through its glass transition, the transition is not itself a phase transition. Upon cooling or heating through this glass-transition range, the material can exhibit a smooth step in the thermal-expansion coefficient and in the specific heat, with the location of these effects being dependent on the mechanical force applied to the material.

The glass transition of a liquid to a solid-like state may occur with either cooling or compression. The transition includes a smooth increase in the viscosity of a material by as much as seventeen orders of magnitude without any pronounced change in material structure. This transition is in contrast to the freezing or crystallization transition, which is a first-order phase transition in the Ehrenfest classification and involves discontinuities in thermodynamic and dynamic properties such as volume, energy, and viscosity. In many materials that normally undergo a freezing transition, rapid cooling can avoid this phase transition and instead result in a glass transition at some lower temperature. Other materials, such as many polymers, lack a well-defined crystalline state and easily form glasses, even upon very slow cooling or compression. The tendency for a material to form a glass while quenched is called glass forming ability. This ability depends on the composition of the material and can be predicted by the rigidity theory.

Below the Tg range, the glassy structure does not relax in accordance with the cooling rate used. The expansion coefficient for the glassy state is roughly equivalent to that of the crystalline solid. If slower cooling rates are used, the increased time for structural relaxation (or intermolecular rearrangement) to occur may result in a higher density glass product. Similarly, by annealing (and thus allowing for slow structural relaxation) the glass structure in time approaches an equilibrium density corresponding to the supercooled liquid at the same temperature. The Tg for a material is typically around the intersection between the cooling curve (volume versus temperature) for the glassy state and the supercooled liquid. The liquid-glass transition is not a transition between states of thermodynamic equilibrium but is primarily a dynamic phenomenon. The Tg for many materials is known and morphing form factor material 10 can include one or more of those materials. For example, morphing form factor material 10 can include one or more of nylon-6 (Tg of about 47° C.), nylon-6,6 (Tg of about 70° C.), poly-vinyl chloride (PVC) (Tg of about 80° C.), polyethene (Tg of about −130° C. to about −80° C.), etc. It should be kept in mind that the example Tg values are only mean values as the glass transition temperature depends on the cooling rate, molecular weight distribution, and can be influenced by additives. The provided examples have been offered for purposes of example and teaching only.

The glass-transition temperature Tg is always lower than the melting temperature (Tm) of the material, if one exists. In addition, a triple shape memory polymer (e.g., morphing form factor material 10) can be created by combining two double shape memory polymers (e.g., two inner cores 12 or one inner core 12 with two separate SMPs 30). A triple shape polymer can have two Tgs, two temporary shapes, and a permanent shape. For example, a morphing form factor material 10 that has a first Tg of about 105° F. (or a Tg higher than a user's body temperature) may be formed to a user's foot. Then, morphing form factor material 10 could also have a second Tg at close to body temperature (98° F.) that will give morphing form factor material 10 a conforming rubbery or cushioning feel when worn. When heated above the first Tg, morphing form factor material 10 can return to its permanent shape and be ready to be custom fit again.

Morphing form factor material 10 may be reinforced with continuous fibers to provide a more rigid composite and allow the permanent shape to have a higher stiffness than the polymer by itself. For example, if morphing form factor material 10 is used for morphing electronic enclosures, then morphing form factor material 10 may be reinforced with continuous fibers. There are an almost infinite set of material modulus and glass transition temperatures that can be designed into morphing form factor material 10 to work with multiple form factors and vast usage conditions.

The ability to change a device shape to take on two or more different form factors enables wearable computers to achieve a custom fit to the user as if the wearable computer was designed custom for the user. The material modulus (hardness) can have the ability to change a hundred fold with a few degrees change in temperature (e.g., hard to soft) and the target Tg can be set to a user's body temperature to allow a wearable computer to be conformal at body temperature and rigid otherwise. In addition, morphing form factor material 10 can allow a device to form new shapes for different usages (e.g., a flat device to a wrist worn device, a flat display to a curved display, etc.) Further, morphing form factor material 10 can allow a device to recover from denting by warming the dented zone and then allowing the dented region to return to its permanent shape. A1so, morphing form factor material 10 can enable electronic enclosures to become sizeable.

Morphing form factor material 10 can be used in devices that include a man/machine interface. Morphing form factor material 10 may also be used in “smart morphing panels” where a panel structure may be designed to control bending uniformity, ease of bending, and configurable stiffness in the deformed condition. For example, placing fibers on outer layers (e.g., polymer layer 14 or outer layer 16) of morphing form factor material 10 can create a stiffness optimized structure while minimizing the use of the fibers. This allows inner core 12 to be fabricated from a SMP material that when heated to the Tg for the SMP, inner core 12 can become low in shear modulus (shear fluidity) and become a controlled slip plane (e.g. slip plane region 20). The slip plane enables the outer panels to act independently when bending so that bending morphing form factor material 10 becomes easy and curvature is uniform and controlled. When morphing form factor material 10 cools, the structure can be stiff and rigid. Additionally, inner core 12 can be designed at strategic modulus levels such that the stiffness range of morphing form factor material 10 is configurable for both T<Tg and T>Tg conditions. Outer layer 16 can be configured to become a protective “hard shell” for the device adding considerably to the durability. In this manner of construction, morphing form factor material 10 may be a thin film which creates the slip plane, and reduces cost of the morphing form factor material 10 material.

Morphing form factor material 10 may be fabricated by laying up the different layers (outer layer 16/polymer layer 14/SMP 30/polymer layer 14/outer layer 16) and then processing under heat to join or polymerize the layers together. In another example, morphing form factor material 10 can also be fabricated by a three step injection molding process where a polymer layer (e.g., polymer layer 14) is injection molded as the first layer, a SMP material (e.g., inner core 12) is injection molded on top of that, and an outer skin (e.g., outer layer 16) is injected molded. The outer skin can include integrated assembly and component integration features.

Morphing form factor material 10 can be configured to include a polymer network where permanent covalent bonds are formed to maintain the permanent shape of morphing form factor material 10. While morphing form factor material 10 has permanent covalent bonds, temporary covalent bonds are also present. By heating morphing form factor material 10 to the Tg for SMP 30, the temporary covalent bonds are broken and morphing form factor material 10 becomes formable. Morphing form factor material 10 can then be formed with mechanical force and cooled below Tg where the temporary covalent bonds form again and help maintain the shape of morphing form factor material 10.

The Tg for morphing form factor material 10 can be formulated at subzero temperatures to temperatures nearing the typical Tg's of thermoplastics (e.g., up to 200° C. and higher). The modulus of morphing form factor material 10 can be changed with temperature. For example, morphing form factor material 10 can be designed with a Tg that allows morphing form factor material 10 to change from 100 MPa to less than 1 MPa in a few degrees temperature change, or over a wide temperature change. The absolute Tg where the modulus change is fully observed can be designed to occur at sub-zero temperatures or far above normal life sustaining temperatures. This allows a material to be relatively stiff for handling and then become soft on body contact (body heat) so that it becomes the same modulus (stiffness) as human flesh. Morphing form factor material 10 can be configured with an absolute stiffness on the order of 0.3 to 0.5 MPSI (million PSI). Materials compatible with morphing form factor material 10 include, but are not limited to, PEEK, PET, PMMA, TMPTA (trimethylolpropane), MA/IBoA (methacrylate), etc.

A treatment such as irradiation may be used to establish covalent bonds and to set the permanent shape of morphing form factor material 10. This may be done in the net shape of the injection mold or in a shape that is constrained to a desired permanent shape. Depending on the material used, the recoverable strain of morphing form factor material 10 may be between −50 to 735%. Morphing form factor material 10 may be included in wearable's such as glasses where the frames and/or earpieces have an integrated morphing form factor material 10 element allowing a custom fit to the user for maximized comfort and retention. In another example, using morphing form factor material 10, a wrist band electronic device can be configured to return to a flat device for storage or flat usage needs such as standing upon a desk. Morphing form factor material 10 could enable a morphing electronic enclosure that morphs to a custom fitting enclosure. Morphing form factor material 10 could also enable a sensor enclosure that can morph to fit comfortably under clothing or within a shoe for instance. This could allow for devices to be comfortable and conforming to wear in nontraditional ways and places so that sensors could be placed closer to areas of interest without discomfort. Morphing form factor material 10 could also be used to open vents when temperature rises in clothing or electronic devices.

Particular embodiments described herein provide for an electronic device, such as a television of any type, a mobile device, a tablet device (e.g., i-Pad™), Phablet™, a personal digital assistant (PDA), a smartphone, an audio system, a movie player of any type, a computer docking station, etc. that includes morphing form factor 10. In still other embodiments, the electronic device may be any suitable electronic device such as a tablet computer, notebook computer, laptop, cellphone, or other electronic device that includes morphing form factor material 10 and a circuit board coupled to a plurality of electronic components (which includes any type of components, elements, circuitry, etc.). The electronic device may also include a display or touchscreen. The display can display an image. In one or more embodiments, the display can be a liquid crystal display (LCD) display screen, a light-emitting diode (LED) display screen, an organic light-emitting diode (OLED) display screen, a plasma display screen, or any other suitable display screen system. The display may be a touchscreen that can detect the presence and location of a touch within the display area.

Turning to FIG. 2, FIG. 2 is a simplified schematic diagram of morphing form factor material 10 in accordance with one embodiment of the present disclosure. As illustrated in FIG. 2, when morphing form factor material 10 is bent, or otherwise physically manipulated, slip plane region 20 enables polymer layer 14 and outer layer 16 to act independently or at least partially independent of inner core 12 when bending so that bending morphing form factor material 10 becomes easy and curvature is uniform and controlled.

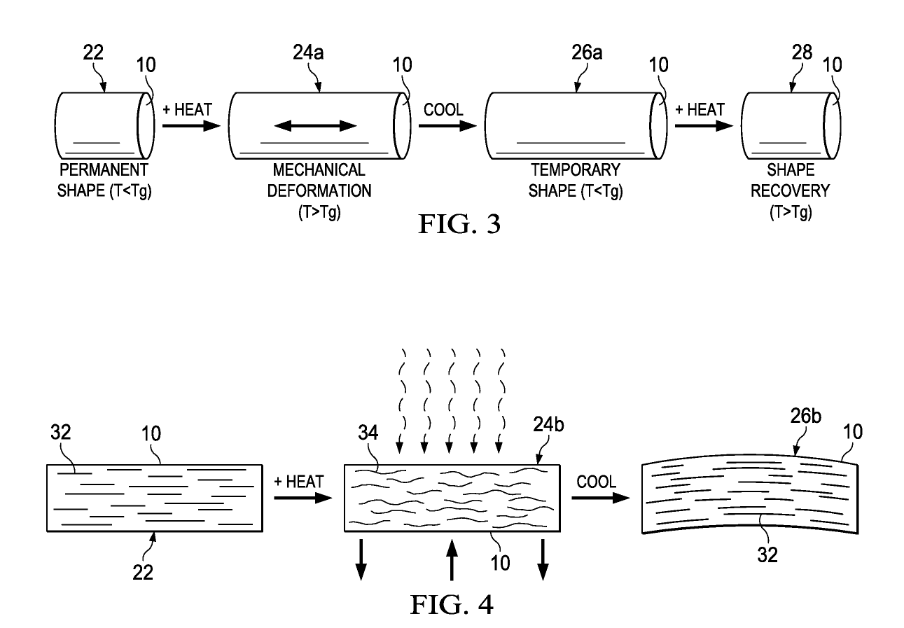

Turning to FIG. 3, FIG. 3 is a simplified block diagram illustrating example details associated with an embodiment of morphing form factor material 10, in accordance with one embodiment of the present disclosure. As illustrated in FIG. 3, morphing form factor material 10 can have a permanent shape 22. As heat is applied to morphing form factor material 10 and the temperature of SMP 30 raises above the Tg for SMP 30, morphing form factor material 10 can undergo a mechanical deformation 24a to transition into a temporary shape. As illustrated in FIG. 3, the mechanical deformation is a pulling or stretching of morphing form factor material 10. As the temperature is cooled and falls below the Tg for SMP 30, morphing form factor material 10 can retain the shape it was mechanically deformed into and remain in a temporary shape 26a until the temperature is again above the Tg for SMP 30. When the temperature is again above the Tg for SMP 30 and morphing form factor material 10 is not constrained or mechanically manipulated, then morphing form factor material 10 can undergo shape recovery 28 and return to permanent shape 22. If morphing form factor material 10 is constrained or mechanically manipulated, then morphing form factor material 10 can be transformed into a new temporary shape.

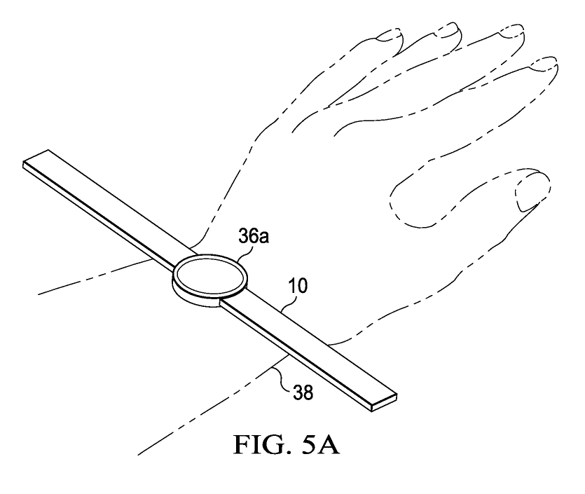

Turning to FIG. 4, FIG. 4 is a simplified block diagram illustrating example details associated with an embodiment of morphing form factor material 10, in accordance with one embodiment of the present disclosure. When the temperature is below Tg, the polymer network inside morphing form factor material 10 (e.g., SMP 30) can be configured to include covalent bonds 32. Covalent bonds 32 help to maintain a permanent shape of morphing form factor material 10. Morphing form factor material 10 can include permanent covalent bonds and temporary covalent bonds. When morphing form factor material 10 is heated to a temperature above Tg (e.g., the Tg for SMP 30 in inner core 12 of morphing form factor material 10), the temporary covalent bonds are broken and morphing form factor material 10 becomes formable and can undergo a mechanical deformation 24b to transition into a temporary shape. As illustrated in FIG. 4, the mechanical deformation is a bending or curving of morphing form factor material 10. When morphing form factor material 10 is cooled, the covalent bonds 32 can form again and help maintain the position of morphing form factor material 10 in temporary shape 26b. Note that morphing form factor material 10 can undergo a pulling or stretching as illustrated in FIG. 3, a bending or curving as illustrated in FIG. 4, a combination of both, or any other type of mechanical deformation that would be allowed by morphing form factor material 10

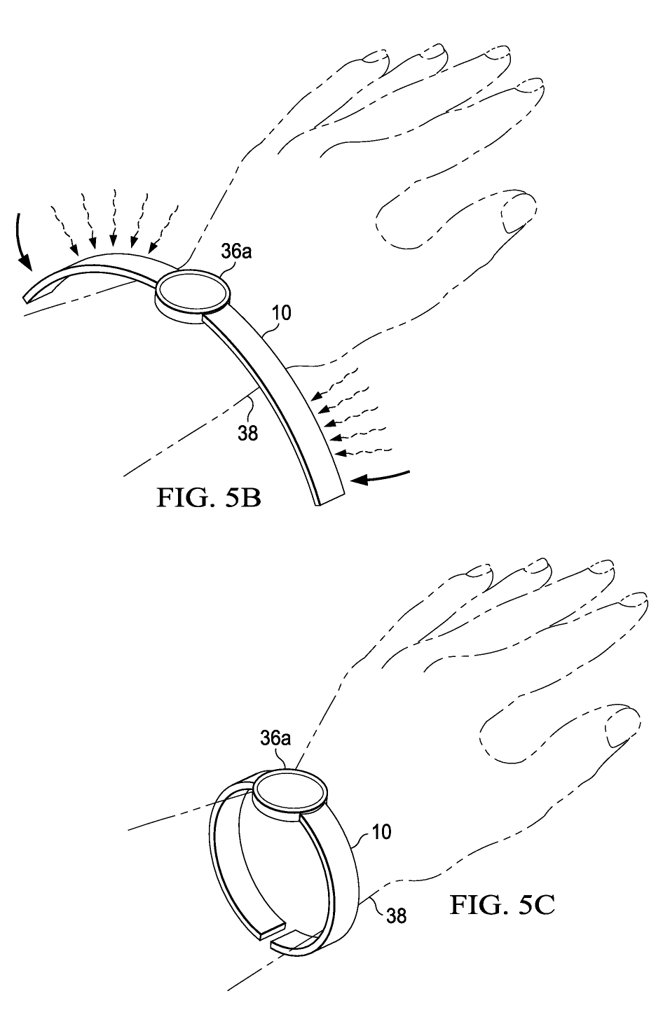

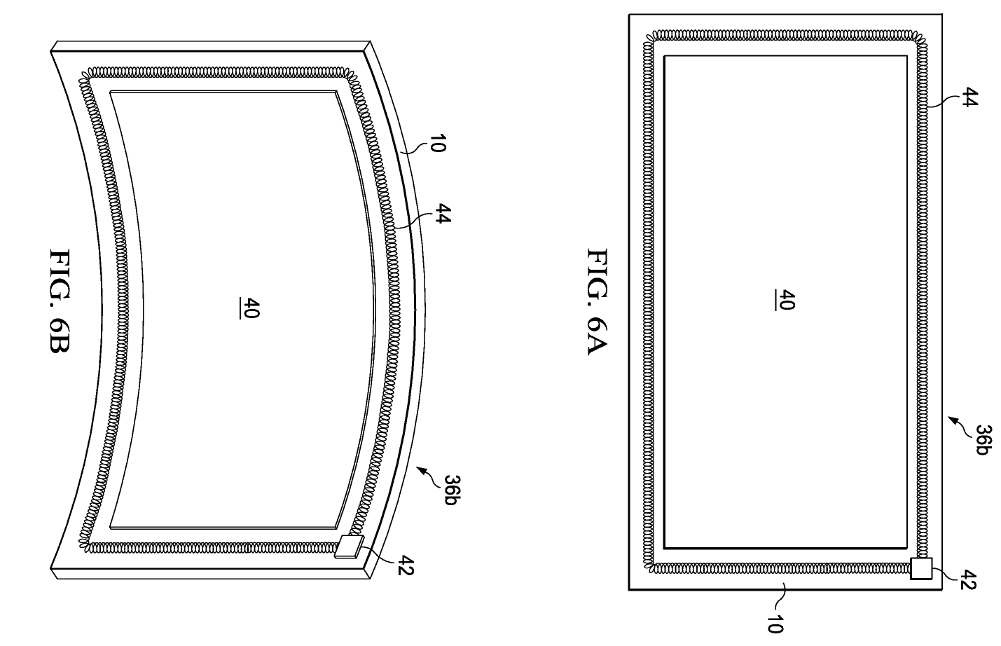

Turning to FIG. 5A, FIG. 5A is a simplified schematic diagram illustrating an embodiment of morphing form factor material 10, in accordance with one embodiment of the present disclosure. As illustrated in FIG. 5A, morphing form factor material 10 can be configured as straps coupled to an electronic device 36a. Electronic device 36a may be an electronic device (e.g., a wearable computer) worn on a wrist 38 of a user.

Turning to FIG. 5B, FIG. 5B is a simplified schematic diagram illustrating an embodiment of morphing form factor material 10, in accordance with one embodiment of the present disclosure. As illustrated in FIG. 5B, heat can be applied to morphing form factor material 10. As the heat is applied to morphing form factor material 10, the temperature of morphing form factor material 10 may rise above the Tg for SMP 30 and thus allow morphing form factor material 10 to be mechanically deformed around wrist 38.

Turning to FIG. 5C, FIG. 5C is a simplified schematic diagram illustrating an embodiment of morphing form factor material 10, in accordance with one embodiment of the present disclosure. As illustrated in FIG. 5C, morphing form factor material 10 has been mechanically deformed around wrist 38. The heat has been removed and the temperature has fallen below the Tg for SMP 30. This allows morphing form factor material 10 to be mechanically deformed into a temporary shape and remain in the temporary shape until the temperature of morphing form factor material 10 raises above the Tg for SMP 30 and morphing form factor material 10 can be mechanically deformed or allowed to return to its permanent shape.

Turning to FIG. 6A, FIG. 6A is a simplified schematic diagram illustrating an embodiment of electronic device 36b, in accordance with one embodiment of the present disclosure. Electronic device can include morphing form factor material 10, a display 40, a heating element activator 42, and a heating element 44. In one or more embodiments, display 40 can be a liquid crystal display (LCD) display screen, a light-emitting diode (LED) display screen, an organic light-emitting diode (OLED) display screen, a plasma display screen, or any other suitable display screen system. Display 40 may be a touchscreen that can detect the presence and location of a touch within the display area.

Heating element activator 42 can be a push button activator, an electronic activator that can be activated with an electronic signal (e.g., an electrical signal from a remote control), a magnetic activator than can be activated by a magnet field, or some other type of activator that a user can activate. When heating element activator 42 is activated, heating element activator 42 causes heating element 44 to generate heat and increase the temperature of morphing form factor material 10. Heating element 44 may be a coiled wire such that when a current is passed through heating element 44, heat is generated. Heating element activator 42 and heating element 44 can be configured to generate enough heat to raise the temperature of morphing form factor material 10 above the Tg for SMP 30.

Turning to FIG. 6B, FIG. 6B is a simplified schematic diagram illustrating an embodiment of electronic device 36b, in accordance with one embodiment of the present disclosure. As illustrated in FIG. 6B, heating element activator 42 was activated and heating element 44 generated enough heat to raise the temperature of morphing form factor material 10 above the Tg for SMP 30 in morphing form factor material 10. Morphing form factor material 10 was mechanically deformed into a curve shape such that electronic device 36b has a curved profile.

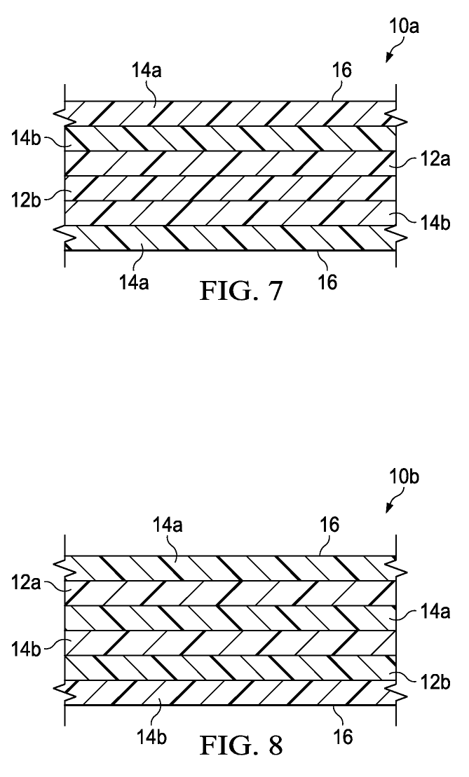

Turning to FIG. 7, FIG. 7 is a simplified block diagram illustrating example details associated with an embodiment of morphing form factor material 10a, in accordance with one embodiment of the present disclosure. Morphing form factor material 10a can include a first inner core 12a, a second inner core 12b, a first polymer layer 14a, a second polymer layer 14b, and outer layer 16. First inner core 12a can be located next to second inner core 12b and can include the same SMP as second inner core 12b or a different SMP then second inner core 12b. First polymer layer 14a can include the same material as second polymer layer 14b or a different material than second polymer layer 14b. By including first inner core 12a and second inner core 12b, morphing form factor material 10a can have two Tgs. For example, SMP material in first inner core 12a may have a Tg several degrees higher than a user's body temperature (e.g., 105° F. and above). This would allow a device to be molded to a user in a temporary shape and remain in the temporary shape when worn as the Tg for first inner core 12a is above the body temperature of the user. A second SMP material in second inner core 12b may have a Tg near the user's body temperature such that when the device is worn, second inner core 12b can give the device a rubbery or cushy feel.

Turning to FIG. 8, FIG. 8 is a simplified block diagram illustrating example details associated with an embodiment of morphing form factor material 10b, in accordance with one embodiment of the present disclosure. Morphing form factor material 10b can include first inner core 12a, second inner core 12b, first polymer layer 14a, second polymer layer 14b, and outer layer 16. First inner core 12a can be separated from second inner core 12b by first polymer layer 14a and second polymer layer 14b. In an embodiment, first inner core 12a is separated from second inner core 12b by either first polymer layer 14a or second polymer layer 14b. First inner core 12a and can include the same SMP as second inner core 12b or a different SMP than second inner core 12b. First polymer layer 14a can include the same material as second polymer layer 14b or a different material than second polymer layer 14b. By including first inner core 12a and second inner core 12b, morphing form factor material 10b can have two Tgs.

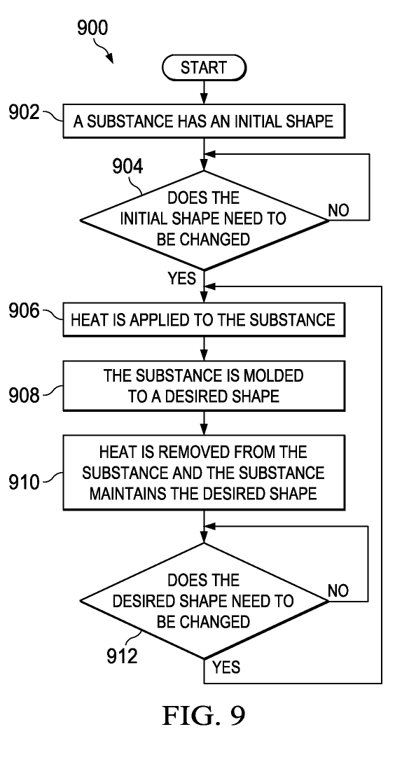

Turning to FIG. 9, FIG. 9 is an example flowchart illustrating possible operations of a flow 900 that may be associated with morphing form factor material 10, in accordance with an embodiment. At 902, a substance (e.g., morphing form factor material 10) has an initial shape (e.g., permanent shape 22). At 904, it is determined if the initial shape needs to be changed. If the initial shape does not need to be changed, then it is again determined if the initial shape needs to be changed, as in 904. If the initial shape does need to be changed, then heat is applied to the substance, as in 906. For example, the heat applied can be sufficient to raise the temperature of the substance above the Tg for the substance. At 908, the substance is molded into a desired shape (e.g., temporary shape 26a). At 910, heat is removed from the substance and the substance maintains the desired shape. At 912, it is determined if the desired shape needs to be changed. If the desired shape does not need to be changed, then it is again determined if the desired shape needs to be changed, as in 912. If the desired shape needs to be changed, then heat is applied to the substance, as in 906. For example, the heat applied can be sufficient to raise the temperature of the substance above the Tg for the substance.

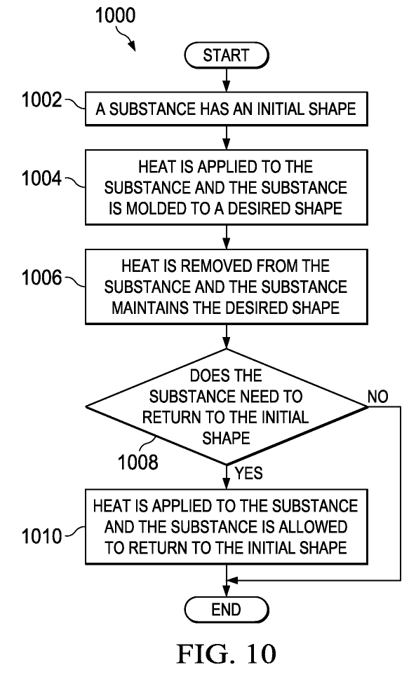

Turning to FIG. 10, FIG. 10 is an example flowchart illustrating possible operations of a flow 1000 that may be associated with morphing form factor material 10, in accordance with an embodiment. At 1002, a substance (e.g., morphing form factor material 10) has an initial shape (e.g., permanent shape 22). At 1004, heat is applied to the substance and the substance is molded to a desired shape (e.g., temporary shape 26a). For example, the heat applied can be sufficient to raise the temperature of the substance above the Tg for the substance. At 1006, heat is removed from the substance and the substance maintains the desired shape. At 1008, it is determined if the substance needs to return to the initial shape. If it is determined that the substance does not need to return to the original shape, the substance is kept in the desired shape. If it is determined that the substance does need to return to the initial shape, then heat is applied to the substance and the substance is allowed to return to the initial shape, as in 1010. For example, the heat applied can be sufficient to raise the temperature of the substance above the Tg for the substance.

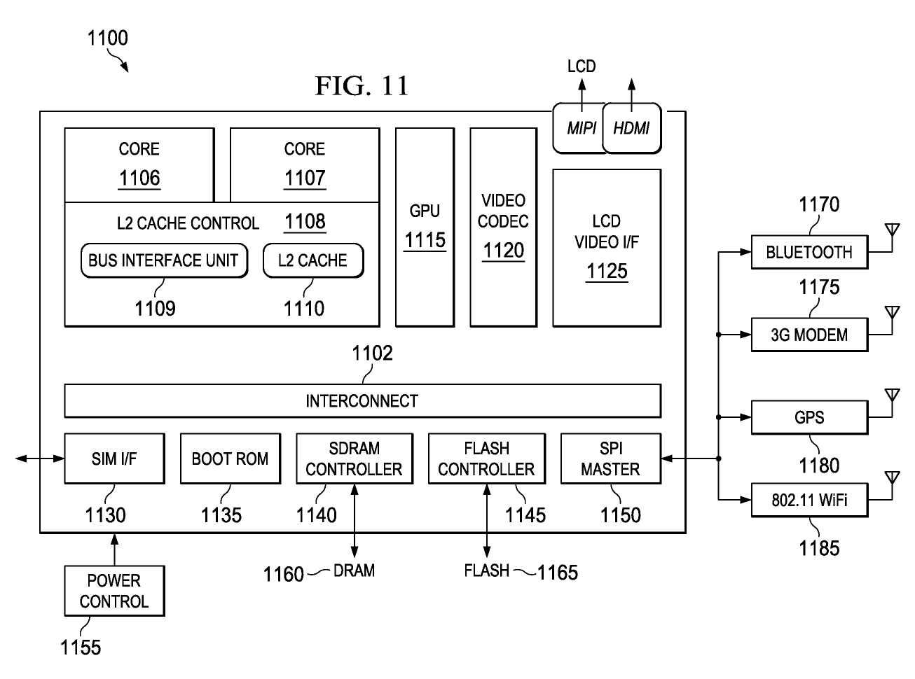

Turning to FIG. 11, FIG. 11 is a simplified block diagram associated with an example ARM ecosystem SOC 1100 of the present disclosure. At least one example implementation of the present disclosure can include the morphing form factor material features discussed herein and an ARM component. For example, the example of FIG. 11 can be associated with any ARM core (e.g., A-9, A-15, etc.). Further, the architecture can be part of any type of electronic device such as a television, wearable computer, tablet, smartphone (inclusive of Android™ phones, iPhones™, iPad™ Google Nexus™, Microsoft Surface™, personal computer, server, video processing components, laptop computer (inclusive of any type of notebook), Ultrabook™ system, any type of touch-enabled input device, etc.

In this example of FIG. 11, ARM ecosystem SOC 1100 may include multiple cores 1106-1107, an L2 cache control 1108, a bus interface unit 1109, an L2 cache 1110, a graphics processing unit (GPU) 1115, an interconnect 1102, a video codec 1120, and a liquid crystal display (LCD) I/F 1125, which may be associated with mobile industry processor interface (MIPI)/high-definition multimedia interface (HDMI) links that couple to an LCD.

ARM ecosystem SOC 1100 may also include a subscriber identity module (SIM) I/F 1130, a boot read-only memory (ROM) 1135, a synchronous dynamic random access memory (SDRAM) controller 1140, a flash controller 1145, a serial peripheral interface (SPI) master 1150, a suitable power control 1155, a dynamic RAM (DRAM) 1160, and flash 1165. In addition, one or more example embodiments include one or more communication capabilities, interfaces, and features such as instances of Bluetooth™ 1170, a 3G modem 1175, a global positioning system (GPS) 1180, and an 802.11 WiFi 1185.

In operation, the example of FIG. 11 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe™ Flash™ Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

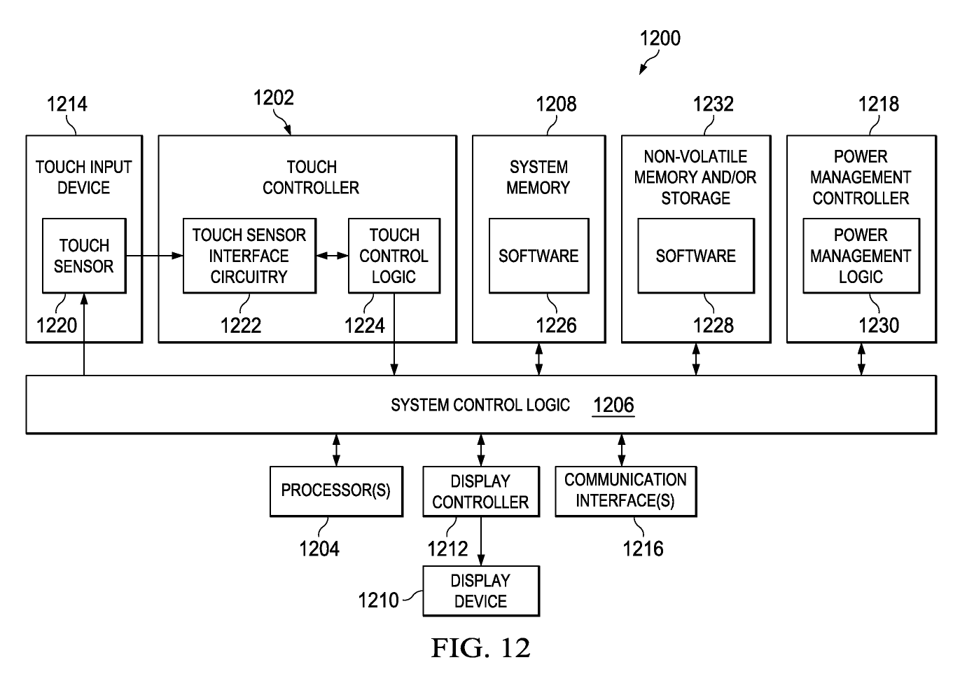

Turning to FIG. 12, FIG. 12 is a simplified block diagram illustrating potential electronics and logic that may be associated with the electronic devices discussed herein. In at least one example embodiment, system 1200 can include a touch controller 1202, one or more processors 1204, system control logic 1206 coupled to at least one of processor(s) 1204, system memory 1208 coupled to system control logic 1206, non-volatile memory and/or storage device(s) 1232 coupled to system control logic 1206, display controller 1212 coupled to system control logic 1206, display controller 1212 coupled to a display device 1210, power management controller 1218 coupled to system control logic 1206, and/or communication interfaces 1216 coupled to system control logic 1206.

Hence, the basic building blocks of any computer system (e.g., processor, memory, I/O, display, etc.) can be used in conjunction with the teachings of the present disclosure. Certain components could be discrete or integrated into a System on Chip (SoC). Some general system implementations can include certain types of form factors in which system 1200 is part of a more generalized enclosure. In alternate implementations, instead of notebook device/laptops, etc., certain alternate embodiments deal with mobile phones, tablet devices, etc.

System control logic 1206, in at least one embodiment, can include any suitable interface controllers to provide for any suitable interface to at least one processor 1204 and/or to any suitable device or component in communication with system control logic 1206. System control logic 1206, in at least one embodiment, can include one or more memory controllers to provide an interface to system memory 1208. System memory 1208 may be used to load and store data and/or instructions, for example, for system 1200. System memory 1208, in at least one embodiment, can include any suitable volatile memory, such as suitable dynamic random access memory (DRAM) for example. System control logic 1206, in at least one embodiment, can include one or more I/O controllers to provide an interface to display device 1210, touch controller 1202, and non-volatile memory and/or storage device(s) 1232.

Non-volatile memory and/or storage device(s) 1232 may be used to store data and/or instructions, for example within software 1228. Non-volatile memory and/or storage device(s) 1232 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 1218 may include power management logic 1230 configured to control various power management and/or power saving functions. In at least one example embodiment, power management controller 1218 is configured to reduce the power consumption of components or devices of system 1200 that may either be operated at reduced power or turned off when the electronic device is in a closed configuration. For example, in at least one embodiment, when the electronic device is in a closed configuration, power management controller 1218 performs one or more of the following: power down the unused portion of the display and/or any backlight associated therewith; allow one or more of processor(s) 1204 to go to a lower power state if less computing power is required in the closed configuration; and shutdown any devices and/or components that are unused when an electronic device is in the closed configuration.

Communications interface(s) 1216 may provide an interface for system 1200 to communicate over one or more networks and/or with any other suitable device. Communications interface(s) 1216 may include any suitable hardware and/or firmware. Communications interface(s) 1216, in at least one example embodiment, may include, for example, a network adapter, a wireless network adapter, a telephone modem, and/or a wireless modem. System control logic 1206, in at least one embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one embodiment, at least one processor 1204 may be packaged together with logic for one or more controllers of system control logic 1206. In at least one embodiment, at least one processor 1204 may be packaged together with logic for one or more controllers of system control logic 1206 to form a System in Package (SiP). In at least one embodiment, at least one processor 1204 may be integrated on the same die with logic for one or more controllers of system control logic 1206. For at least one embodiment, at least one processor 1204 may be integrated on the same die with logic for one or more controllers of system control logic 1206 to form a System on Chip (SoC).

For touch control, touch controller 1202 may include touch sensor interface circuitry 1222 and touch control logic 1224. Touch sensor interface circuitry 1222 may be coupled to detect, using a touch sensor 1220, touch input over a first touch surface layer and a second touch surface layer of a display (i.e., display device 1210). Touch sensor interface circuitry 1222 may include any suitable circuitry that may depend, for example, at least in part on the touch-sensitive technology used for a touch input device 1214. Touch sensor interface circuitry 1222, in one embodiment, may support any suitable multi-touch technology. Touch sensor interface circuitry 1222, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 1224 may be coupled to help control touch sensor interface circuitry 1222 in any suitable manner to detect touch input over a first touch surface layer and a second touch surface layer. Touch control logic 1224 for at least one example embodiment may also be coupled to output in any suitable manner digital touch input data corresponding to touch input detected by touch sensor interface circuitry 1222. Touch control logic 1224 may be implemented using any suitable logic, including any suitable hardware, firmware, and/or software logic (e.g., non-transitory tangible media), that may depend, for example, at least in part on the circuitry used for touch sensor interface circuitry 1222. Touch control logic 1224 for at least one embodiment may support any suitable multi-touch technology.

Touch control logic 1224 may be coupled to output digital touch input data to system control logic 1206 and/or at least one processor 1204 for processing. At least one processor 1204 for at least one embodiment may execute any suitable software to process digital touch input data output from touch control logic 1224. Suitable software may include, for example, any suitable driver software and/or any suitable application software. As illustrated in FIG. 12, system memory 1208 may store suitable software 1226 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

It is imperative to note that all of the specifications, dimensions, and relationships outlined herein (e.g., configurations, height, width, length, materials, etc.) have only been offered for purposes of example and teaching only. Each of these data may be varied considerably without departing from the spirit of the present disclosure, or the scope of the appended claims. The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example A1 is a morphing material that includes an outer layer, a polymer layer, and an inner core. The polymer layer can be between the inner core and the outer layer and the inner core can include a shape memory polymer. The shape memory polymer has a known glass transition temperature. The morphing material can be mechanically deformed to a temporary shape when a temperature of the shape memory polymer is at or above the glass transition temperature.

In Example A2, the subject matter of Example A1 may optionally include where the shape memory polymer includes covalent bonds and some of the covalent bonds are broken when the temperature of the shape memory polymer is at or above the glass transition temperature.

In Example A3, the subject matter of any of the preceding ‘A’ Examples can optionally include where a slip plane is created when the temperature of the shape memory polymer is at or above the glass transition temperature and the slip plane allows the polymer layer and outer layer to act at least partially independent of the inner core.

In Example A4, the subject matter of any of the preceding ‘A’ Examples can optionally include where the morphing material includes a permanent shape and the morphing material can transition from the temporary shape to the permanent shape when the temperature of the shape memory polymer is at or above the glass transition temperature.

In Example A5, the subject matter of any of the preceding ‘A’ Examples can optionally include where the polymer layer includes fibers to increase the stiffness of the morphing material.

In Example A6, the subject matter of any of the preceding ‘A’ Examples can optionally include a second shape memory polymer, where the second shape memory polymer has a known second glass transition temperature that is different than the glass transition temperature.

In Example A7, the subject matter of any of the preceding ‘A’ Examples can optionally include a second inner core, where the second inner core is next to the inner core and the second inner core includes a second shape memory polymer and the second shape memory polymer has a known second glass transition temperature.

In Example A8, the subject matter of any of the preceding ‘A’ Examples can optionally include where the glass transition temperature is about the temperature of a user that is using the morphing material.

Example M1 is a method that includes heating a material to a temperature above a glass transition temperature for the material and deforming the material. The material can include an outer layer, a polymer layer, and an inner core. The polymer layer can be between the inner core and the outer layer and the inner core can include a shape memory polymer. The material can be mechanically deformed to a temporary shape when a temperature of the shape memory polymer is at or above the glass transition temperature.

In Example M2, the subject matter of any of the preceding ‘M’ Examples can optionally include where the shape memory polymer includes covalent bonds and some of the covalent bonds are broken when the temperature of the shape memory polymer is at or above the glass transition temperature.

In Example M3, the subject matter of any of the preceding ‘M’ Examples can optionally include where a slip plane is created when the temperature of the shape memory polymer is at or above the glass transition temperature and the slip plane allows the polymer layer and outer layer to act at least partially independent of the inner core.

In Example M4, the subject matter of any of the preceding ‘M’ Examples can optionally include where the material is mechanically deformed into a temporary shape.

In Example M5, the subject matter of any of the preceding ‘M’ Examples can optionally include re-heating the material to a temperature above the glass transition temperature, where, in reaction to the re-heating, the material transitions from the temporary shape to a permanent shape without any intervention.

In Example M6, the subject matter of any of the preceding ‘M’ Examples can optionally include where the material further includes a second shape memory polymer, where the second shape memory polymer has a known second glass transition temperature that is different than the glass transition temperature.

In Example M7, the subject matter of any of the preceding ‘M’ Examples can optionally include where the material further includes a second inner core, where the second inner core is next to the inner core and the second inner core includes a second shape memory polymer and the second shape memory polymer has a known second glass transition temperature.

Example AA1 is an electronic device that includes a plurality of electronic components and a morphing material coupled to at least one of the plurality of electronic components. The morphing material can include an outer layer, a polymer layer, and an inner core. The polymer layer can be between the inner core and the outer layer and the inner core can include a shape memory polymer. The shape memory polymer has a known glass transition temperature. The morphing material can be mechanically deformed to a temporary shape when a temperature of the shape memory polymer is at or above the glass transition temperature

In Example AA2, the subject matter of Example AA1 may optionally include where the shape memory polymer includes covalent bonds and some of the covalent bonds are broken when the temperature of the shape memory polymer is at or above the glass transition temperature.

In Example AA3, the subject matter of any of the preceding ‘AA’ Examples can optionally include where a slip plane is created when the temperature of the shape memory polymer is at or above the glass transition temperature and the slip plane allows the polymer layer and outer layer to act at least partially independent of the inner core.

In Example AA4, the subject matter of any of the preceding ‘AA’ Examples can optionally include where the morphing material includes a permanent shape and the morphing material can transition from the temporary shape to the permanent shape when the temperature of the shape memory polymer is at or above the glass transition temperature.

In Example AA5, the subject matter of any of the preceding ‘AA’ Examples can optionally include a second shape memory polymer, where the second shape memory polymer has a known second glass transition temperature that is different than the glass transition temperature.

In Example AA6, the subject matter of any of the preceding ‘AA’ Examples can optionally include a second inner core, where the second inner core is next to the inner core and the second inner core includes a second shape memory polymer and the second shape memory polymer has a known second glass transition temperature.

An example system S1 can include a means for heating a material to a temperature above a glass transition temperature for the material and a means for deforming the material. The material can include an outer layer, a polymer layer, and an inner core. The polymer layer can be between the inner core and the outer layer and the inner core can include a shape memory polymer. The material can be mechanically deformed to a temporary shape when a temperature of the shape memory polymer is at or above the glass transition temperature.

In Example S2, the subject matter of any of the preceding ‘S’ Examples can optionally include where the shape memory polymer includes covalent bonds and some of the covalent bonds are broken when the temperature of the shape memory polymer is at or above the glass transition temperature.

In Example S3, the subject matter of any of the preceding ‘S’ Examples can optionally include where a slip plane is created when the temperature of the shape memory polymer is at or above the glass transition temperature and the slip plane allows the polymer layer and outer layer to act at least partially independent of the inner core.

In Example S4, the subject matter of any of the preceding ‘S’ Examples can optionally include a means for heating the material to a temperature above a second glass transition temperature for the material. The material can further include a second inner core, where the second inner core includes a second shape memory polymer and the second glass transition temperature is associated with the second shape memory polymer.

Example X1 is a machine-readable storage medium including machine-readable instructions to implement a method or realize an apparatus as in any one of the Examples A1-A8, M1-M7, and AA1-AA6. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. A morphing material, comprising:
an outer layer;
a polymer layer; and
an inner core, wherein the polymer layer is between the inner core and the outer layer, wherein the inner core includes a shape memory polymer and the shape memory polymer has a known glass transition temperature, wherein the morphing material can be mechanically deformed to a temporary shape when a temperature of the shape memory polymer is at or above the glass transition temperature.

2. The morphing material of claim 1, wherein the shape memory polymer includes covalent bonds and some of the covalent bonds are broken when the temperature of the shape memory polymer is at or above the glass transition temperature.

3. The morphing material of claim 1, wherein a slip plane is created when the temperature of the shape memory polymer is at or above the glass transition temperature and the slip plane allows the polymer layer and outer layer to act at least partially independent of the inner core.

4. The morphing material of claim 1, wherein the morphing material includes a permanent shape and the morphing material can transition from the temporary shape to the permanent shape when the temperature of the shape memory polymer is at or above the glass transition temperature.

5. The morphing material of claim 1, wherein the polymer layer includes fibers to increase the stiffness of the morphing material.

6. The morphing material of claim 1, further comprising:
a second shape memory polymer, wherein the second shape memory polymer has a known second glass transition temperature that is different than the glass transition temperature.

7. The morphing material of claim 1, further comprising:
a second inner core, wherein the second inner core is next to the inner core and the second inner core includes a second shape memory polymer and the second shape memory polymer has a known second glass transition temperature.

8. The morphing material of claim 1, wherein the glass transition temperature is about the temperature of a user that is using the morphing material.

9. A method, comprising:
heating a material to a temperature above a glass transition temperature for the material, wherein the material includes:
an outer layer;
a polymer layer; and
an inner core, wherein the polymer layer is between the inner core and the outer layer, wherein the inner core includes a shape memory polymer, wherein the material can be mechanically deformed to a temporary shape when a temperature of the shape memory polymer is at or above the glass transition temperature; and
deforming the material.

10. The method of claim 9, wherein the shape memory polymer includes covalent bonds and some of the covalent bonds are broken when the temperature of the shape memory polymer is at or above the glass transition temperature.

11. The method of claim 9, wherein a slip plane is created when the temperature of the shape memory polymer is at or above the glass transition temperature and the slip plane allows the polymer layer and outer layer to act at least partially independent of the inner core.

12. The method of claim 9, wherein the material is mechanically deformed into a temporary shape.

13. The method of claim 12, further comprising:
re-heating the material to a temperature above the glass transition temperature, wherein, in reaction to the re-heating, the material transitions from the temporary shape to a permanent shape without any intervention.

14. The method of claim 9, wherein the material further includes a second shape memory polymer, wherein the second shape memory polymer has a known second glass transition temperature that is different than the glass transition temperature.

15. The method of claim 9, wherein the material further includes a second inner core, wherein the second inner core is next to the inner core and the second inner core includes a second shape memory polymer and the second shape memory polymer has a known second glass transition temperature.

16. An electronic device, comprising:
a plurality of electronic components; and
a morphing material coupled to at least one of the plurality of electronic components, wherein the morphing material includes:
an outer layer;
a polymer layer; and
an inner core, wherein the polymer layer is between the inner core and the outer layer, wherein the inner core includes a shape memory polymer and the shape memory polymer has a known glass transition temperature, wherein the morphing material can be mechanically deformed to a temporary shape when a temperature of the shape memory polymer is at or above the glass transition temperature.

17. The electronic device of claim 16, wherein the shape memory polymer includes covalent bonds and some of the covalent bonds are broken when the temperature of the shape memory polymer is at or above the glass transition temperature.

18. The electronic device of claim 16, wherein a slip plane is created when the temperature of the shape memory polymer is at or above the glass transition temperature and the slip plane allows the polymer layer and outer layer to act at least partially independent of the inner core.

19. The electronic device of claim 16, wherein the morphing material includes a permanent shape and the morphing material can transition from the temporary shape to the permanent shape when the temperature of the shape memory polymer is at or above the glass transition temperature.

20. The electronic device of claim 16, wherein the morphing material further includes:
a second shape memory polymer, wherein the second shape memory polymer has a known second glass transition temperature that is different than the glass transition temperature.

21. The electronic device of claim 16, wherein the morphing material further includes:
a second inner core, wherein the second inner core is next to the inner core and the second inner core includes a second shape memory polymer and the second shape memory polymer has a known second glass transition temperature.

22. A system, comprising:
means for heating a material to a temperature above a glass transition temperature for the material, wherein the material includes:
an outer layer;
a polymer layer; and
an inner core, wherein the polymer layer is between the inner core and the outer layer, wherein the inner core includes a shape memory polymer, wherein the material can be mechanically deformed to a temporary shape when a temperature of the shape memory polymer is at or above the glass transition temperature; and
means for deforming the material.

23. The system of claim 22, wherein the shape memory polymer includes covalent bonds and some of the covalent bonds are broken when the temperature of the shape memory polymer is at or above the glass transition temperature.

24. The system of claim 22, wherein a slip plane is created when the temperature of the shape memory polymer is at or above the glass transition temperature and the slip plane allows the polymer layer and outer layer to act at least partially independent of the inner core.

25. The system of claim 22, further comprising:
means for heating the material to a temperature above a second glass transition temperature for the material, wherein the material further includes:
a second inner core, wherein the second inner core includes a second shape memory polymer and the second glass transition temperature is associated with the second shape memory polymer.
